(19) United States
(12) Patent Application Publication
(10) Pub. No.: US 2006/0245477 A1
(43) Pub. Date: Nov. 2, 2006

(54) CDMA reception method, device, and wireless communication system

(75) Inventor: Shousei Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/410,026

(22) Filed: Apr. 25, 2006

(30) Foreign Application Priority Data
Apr. 27, 2005 (JP) 129796/2005

(51) Int. Cl. H04B 1/707; H04K 1/10

(52) U.S. Cl. 375/148; 375/260

(57) ABSTRACT

In an arrangement for receiving CDMA signals, insertion of guard intervals is rendered unnecessary and transmission efficiency loss is suppressed, along with greatly reducing the computational burden of weight calculations. Impulse responses of a transmission channel are obtained by time-domain signal processing, the impulse responses are Fourier transformed and converted into frequency domain signals, equalizing filter weights are calculated using the frequency domain impulse responses, the calculated frequency domain weights are converted to time domain weights using an inverse Fourier transform, the received signals are filtered using time-domain signal processing, and data signals are demodulated by despreading the equalized signals.

### BACKGROUND OF THE INVENTION

1. Field of the Invention

The present invention relates to wireless communications based on the Code Division Multiplex (CDMA: Code Division Multiple Access) system. In particular, it relates to a CDMA reception method and device, in which demodulation of signals is performed by equalizing the received CDMA signals using a linear filter, as well as to a wireless communication system based thereon.

2. Description of Related Art

The DS-CDMA (Direct Sequence-Code Division Multiple Access) system, which permits effective suppression of interference from other cells and implementation of one-cell repeat in multi-cell environments, is used as a wireless access system for mobile communications. Moreover, under the CDMA system, path diversity effects are obtained by separating and RAKE combining the multipaths of a transmission channel during despreading.

However, in recent years, in addition to audio communications, there has been an increase in data communications traffic, which generates demand for greater capacity and increased rates and makes multi-code transmission necessary. The problem arising when multi-code transmission is carried out using CDMA consists in the reduction in the effective spreading gain, which makes it impossible to adequately suppress multipath interference.

Consequently, investigations have been conducted into methods, in which despreading and signal demodulation are carried out after performing transmission channel equalization (chip equalization) prior to despreading so as to restore orthogonality between the multiple codes. Although various methods of equalization have been proposed, linear filter-based methods offer greater simplicity, such as, for instance, the method described in “Comparative characteristics of chip equalizers and multipath interference cancellers with account taken of elimination of interference from other cells in HSDPA”, by Kawamura, Kishiyama, Higuchi, Sawahashi, IEICE Technical Report RCS2002-38, April 2002 (hereinafter, referred to as “non-patent document 1”).

A conventional CDMA receiver is illustrated in the block diagram of FIG. 3. The technology described in non-patent document 1 will be explained by referring to this diagram.

The conventional device, which is called a “chip equalizer”, is made up of pilot despreading sections 21-1 to 21-L, a transmission channel estimation section 22, a weight calculation section 23, an equalizing filter 24, and a data despreading section 25. The pilot despreading sections 21-1 to 21-L receive CDMA signals multiplexed with pilot signals and despread the pilot signals for each path in accordance with path timing. The channel estimation section 22 accepts the pilot-despread signals of each path as input and averages the respective signals over a plurality of symbols to obtain transmission channel estimates (impulse responses of the transmission channel) for each path. The weight calculation section 23 accepts the transmission channel estimates for each path as input and calculates equalizing filter weights W. The equalizing filter 24 uses the central row vectors of the weights W calculated by the weight calculation section 23 as tap weights and performs filtering (equalization) of the received signals. The data despreading section 25 despreads the equalized signals and demodulates the data signals.

For instance, when using the minimum mean square error method (MMSE: Minimum Mean Square Error), the calculation of the weights W is carried out according to the following formula.
W=(Ĥ^{H}Ĥ+σ²I)⁻¹Ĥ^{H} (1)

where

the superscript H designates a conjugate transpose of the matrix,

σ² designates noise power, and

Ĥ is a channel matrix obtained by arranging transmission channel estimates ĥi for each path in columns, time-shifted on a sample-by-sample basis.

$$\hat{H} = [ \begin{matrix}{\hat{h}}_{0} & & & 0 \\ 0 & {\hat{h}}_{0} & & \\ {\hat{h}}_{1} & 0 & ⋰ & \\ & {\hat{h}}_{1} & ⋰ & {\hat{h}}_{0} \\ & & ⋰ & 0 \\ 0 & & & {\hat{h}}_{1}\end{matrix} ]$$

Although channel estimation, weight calculation, and filtering (equalization) in the conventional example illustrated in FIG. 3 are carried out using time domain signal processing, there also exist methods, in which these processing operations are performed in the frequency domain, as in “Frequency Domain Equalization for Single-Carrier Broadband Wireless Systems” by D. Falconer, S. L. Ariyavisitakul, A. Benyamin-Seeyar and B. Eidson, IEEE Commun. Mag., Vol. 33, No. 2, pp. 100-109, February 1995, where they are introduced in the form of a frequency domain equalizer. Moreover, “An investigation into increasing rates and capacity in single-carrier transmission based CDMA cellular systems” by Suzuki, Miyazaki, Fukuhara, Takeuchi, IEICE Technical Report RCS2002-349, March 2003 describes an example, in which such a frequency domain equalizer is applied to CDMA.

A block diagram of a conventional CDMA receiver utilizing a frequency domain equalizer is shown in FIG. 4. The technology described in non-patent document 3 will be explained by referring to this diagram. The conventional example, which is called a “frequency domain chip equalizer”, is made up of a GI removal section 31, a switch 32, a serial-to-parallel (S/P) conversion section 33, a fast Fourier transform (FFT) section 34, a channel estimation section 35, a weight calculation section 36, a serial-to-parallel conversion section 37, a fast Fourier transform section 38, an equalizing filter 39, an inverse fast Fourier transform (IFFT) section 40, a parallel-to-serial (P/S) conversion section 41, and a data despreading section 42.

Before explaining the operation of the conventional example illustrated in FIG. 4, FIG. 5 and FIG. 6 will be used to provide an explanation of the guard intervals (GI), which are required when using a frequency domain equalizer.

To perform channel estimation, weight calculation, and filtering using frequency-domain signal processing, in the frequency domain equalizer the received signal is Fourier transformed and converted to a frequency-domain received signal. To use the frequency domain equalizer, guard intervals (GI) have to be inserted in each block unit Fourier transformed at the transmitter. As shown in FIG. 5, the commonly used method, called cyclic prefixing, consists in copying the last portion of the data and the pilot and moving them in front of the block.

FIG. 6 is a diagram used to explain the effects of GI insertion. When a plurality of paths are received at the receiver and blocks Fourier transformed according to the timing of path A are cut out, failure to append GIs results in interference from the preceding block on path B (FIG. 6 (a)) and appending GIs makes it possible to avoid interference despite the infiltration of the GI portion from path B because the signal is produced by cyclically shifting the last portions of the blocks (FIG. 6 (b)).

Now, explanations will be provided regarding the operation of the conventional example illustrated in FIG. 4.

The GI removal section 31 removes the GI portion of the received signal based on the timing of the preceding path. The switch 32 is switched to output blocks of the pilot signals of the received signals to the weight calculation processing section or output blocks of the data signals to the filtering section.

The serial-to-parallel conversion section 33 performs serial-to-parallel conversion of pilot signals. The FFT section 34 Fourier transforms pilot signals so as to convert them into frequency domain signals. To remove the spreading modulation of the pilot signals converted to the frequency domain, the channel estimation section 35 multiplies them in the frequency domain by signals produced by separately Fourier transforming the spreading chips of the pilot signals, thereby obtaining frequency-domain transmission channel estimates. The weight calculation section 36 accepts the frequency-domain transmission channel estimates as input and calculates equalizing filter weights. For instance, when using the minimum mean square error method (MMSE), the calculation of weight w(m) at point m in the frequency domain is performed according to the following formula.

$$W ( m ) = \frac{\hat{h} * ( m )}{{\vert \hat{h} ( m ) \vert}^{2} + {σ}^{2}} \qquad ( 2 )$$

where

the subscript * designates a complex conjugate,

σ² designates noise power, and

ĥi(m) is a transmission channel estimate for point m in the frequency domain.

The serial-to-parallel conversion section 37 performs serial-to-parallel conversion of data signals. The FFT section 38 Fourier transforms the data signals so as to convert them into frequency domain signals. The equalizing filter 39 performs filtering (equalization) of the received signals in the frequency domain with the help of the weights calculated by the weight calculation section 36. The equalizing filter 39, which is made up of a plurality of multipliers, multiplies the received signals by the weights for each point. The fast Fourier transform section 40 Fourier transforms the equalized signals so as to convert them into time domain signals. The parallel-to-serial conversion section 41 performs parallel-to-serial-conversion of the equalized signals converted to the time domain. The data despreading section 42 despreads the equalized signals and demodulates the data signals.

In the conventional CDMA receiver illustrated in FIG. 3, which performs chip equalization in the time domain, weight calculation requires computation of an inverse matrix, such as the one shown in formula (1), and the computational burden increases in proportion to the cube of the size of the matrix (or the number of taps in the equalizing filter). In particular, in case of broadband CDMA with high chip rates, in a macro-cell environment with long propagation delays, the required number of taps may be as high as several hundred and the number of arithmetic operations required for inverse matrix computation becomes enormous. On the other hand, in a conventional CDMA receiver performing chip equalization in the frequency domain, such as the one illustrated in FIG. 4, performing multiplication and division according formula (2) once for each point is sufficient for weight calculation, which dramatically reduces the computational burden in comparison with inverse matrix computation. However, to use the frequency domain equalizer, GIs have to be inserted in the CDMA signal in order to eliminate interference between FFT blocks, which reduces the efficiency of transmission.

### SUMMARY OF THE INVENTION

The present invention provides a CDMA reception method and device, and a wireless communication system that can eliminate such problems and minimize loss of transmission efficiency by rendering GI insertion unnecessary, and, on the other hand, can greatly reduce the computational burden of weight calculations.

The present invention is characterized in that, in an arrangement wherein received CDMA signals are demodulated by equalizing the signals with the help of a linear filter, signal processing used for channel estimation and filtering (equalization) is performed in the time domain and only weight calculation-related signal processing is performed in the frequency domain.

Namely, according to a first aspect of the present invention, there is a provided a CDMA receiver comprising an equalizing filter equalizing received code division multiplex (CDMA) signals, data despreading means demodulating data signals by despreading equalized signals, channel estimation means obtaining the impulse responses of the transmission channel, and weight calculation means calculating the weights of the equalizing filter based on the obtained impulse responses, wherein the receiver is adapted such that signal processing is performed, respectively, in the real time domain by the channel estimation means and the equalizing filter and in the frequency domain by the weight calculation means, and comprises Fourier transform means for converting the impulse responses obtained by the channel estimation means into frequency domain signals and inverse Fourier transform means for converting the frequency domain weights calculated by the weight calculation means into time domain weights.

In addition to the CDMA reception technology, the orthogonal frequency division Multiplex (OFDM: Orthogonal Frequency Division Multiplex) system is known as a technology for channel estimation, weight calculation, and filtering. During the equalization (transmission channel correction) of OFDM signals, the respective signal processing related to weight calculation and filtering is carried out in the frequency domain, in the same manner as frequency domain equalization of CDMA signals. Weight calculation-related signal processing in the frequency domain and filtering-related signal processing in the time domain have heretofore been unknown in technologies such as CDMA and OFDM.

The minimum mean square error method (MMSE: Minimum Mean Square Error) can be used as a method of weight calculation in the weight calculation means.

According to a second aspect of the present invention, there is provided a CDMA reception method for receiving signals transmitted under the CDMA system, wherein impulse responses of a transmission channel are obtained by time-domain signal processing, the impulse responses are Fourier transformed and converted into frequency domain signals, equalizing filter weights are calculated using the frequency domain impulse responses, the calculated frequency domain weights are converted to time domain weights using an inverse Fourier transform, the received signals are filtered using time-domain signal processing, and data signals are demodulated by despreading the equalized signals.

According to a third aspect of the present invention, there is provided a wireless communication system characterized by comprising a transmitter(s), which transmits code division multiplex signals, and the CDMA receiver(s) described above, which receives signals transmitted by the transmitter(s).

In the present invention, signal processing used for channel estimation and filtering (equalization) is performed in the time domain and only weight calculation-related signal processing is performed in the frequency domain. The computational burden of weight calculation can be greatly reduced by performing weight calculation-related signal processing in the frequency domain. On the other hand, GI insertion is rendered unnecessary and transmission efficiency losses can be suppressed by performing channel estimation and filtering (equalization)-related signal processing in the time domain.

### BRIEF DESCRIPTION OF THE DRAWINGS

Specific embodiments of the present invention will now be described, by way of example only, with reference to the accompanying drawings in which:

FIG. 1 is a block diagram illustrating a working example of the CDMA receiver of the present invention;

FIG. 2 is a block diagram illustrating an exemplary equalizing filter;

FIG. 3 is a block diagram illustrating an example of a conventional CDMA receiver;

FIG. 4 is a block diagram illustrating another conventional example;

FIG. 5 is a diagram illustrating signal composition used by a frequency domain equalizer; and

FIG. 6 is a diagram used to explain the effects of guard interval (GI) insertion.

### DETAILED DESCRIPTION OF THE PREFERRED EMBODIMENTS

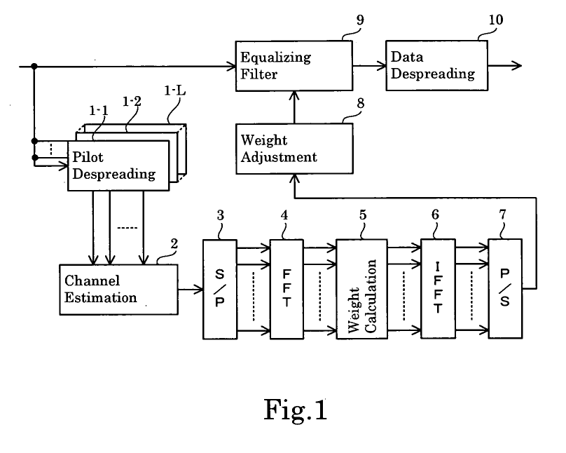

An embodiment of the present invention will be now explained by referring to drawings. FIG. 1 is a block diagram illustrating a working example of the CDMA receiver of the present invention. The CDMA receiver is made up of pilot despreading sections 1-1 to 1-L, a channel estimation section 2, a serial-to-parallel (S/P) conversion section 3, a fast Fourier transform (FFT) section 4, a weight calculation section 5, an inverse fast Fourier transform (IFFT) section 6, a parallel-to-serial (P/S) conversion section 7, a weight adjustment section 8, an equalizing filter 9, and a data despreading section 10.

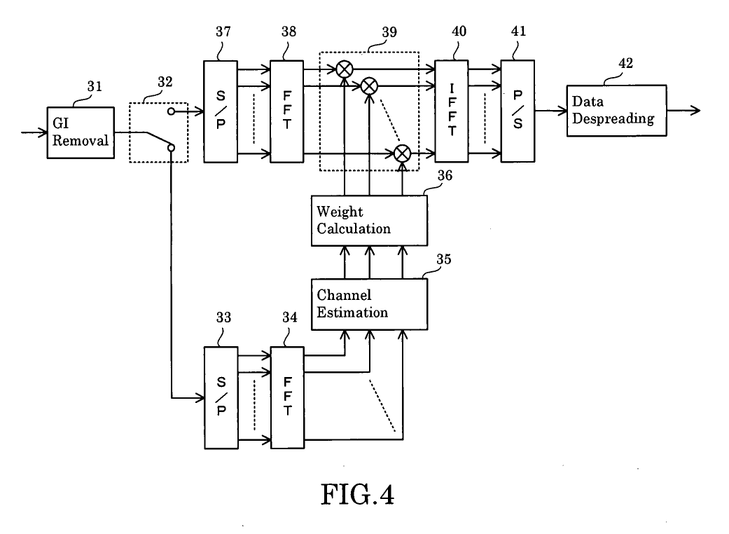

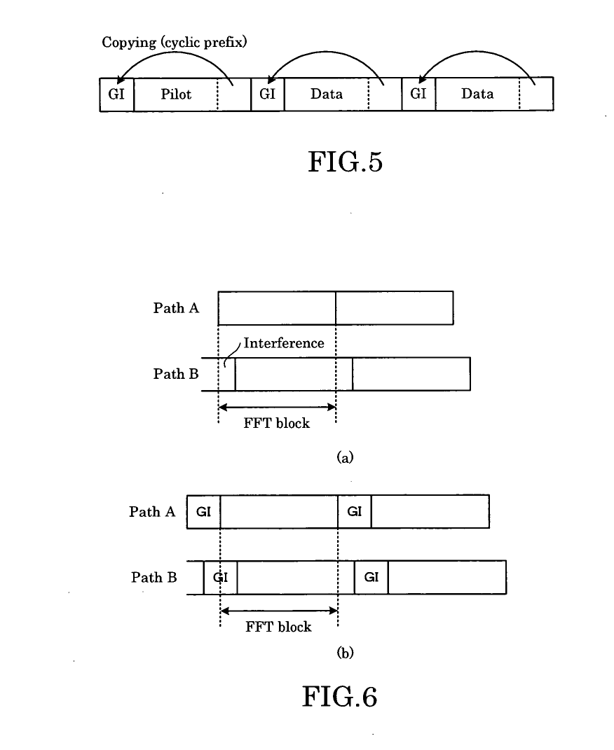

The pilot despreading sections 1-1 to 1-L receive CDMA signals multiplexed with pilot signals and despread the pilot signals for each path in accordance with path timing. The channel estimation section 2 accepts the pilot-despread signals of each path as input and averages the respective signals over a plurality of symbols to obtain transmission channel estimates (impulse responses of the transmission channel) for each path. The serial-to-parallel conversion section 3 performs serial-to-parallel conversion of the impulse responses of the transmission channel. The fast Fourier transform section 4 Fourier transforms the impulse responses of the transmission channel so as to convert them into frequency domain signals. The weight calculation section 5 accepts the frequency-domain transmission channel estimates as input and calculates equalizing filter weights. When using the minimum mean square error method (MMSE), the calculation of weight w(m) at point m in the frequency domain is carried out according to formula (2) as in the conventional example illustrated in FIG. 4. The inverse fast Fourier transform section 6 converts the calculated frequency domain weights into time domain weights. The parallel-to-serial conversion section 7 performs parallel-to-serial-conversion of the time domain weights. To generate weights matching the number of taps in the equalizing filter, the weight adjustment section 8 carries out tap number truncation processing and weight level normalization processing. The equalizing filter 9 performs the filtering (equalization) of the received signals with the help of the tap weights generated by the weight adjustment section 8. The data despreading section 10 despreads the equalized signals and demodulates the data signals.

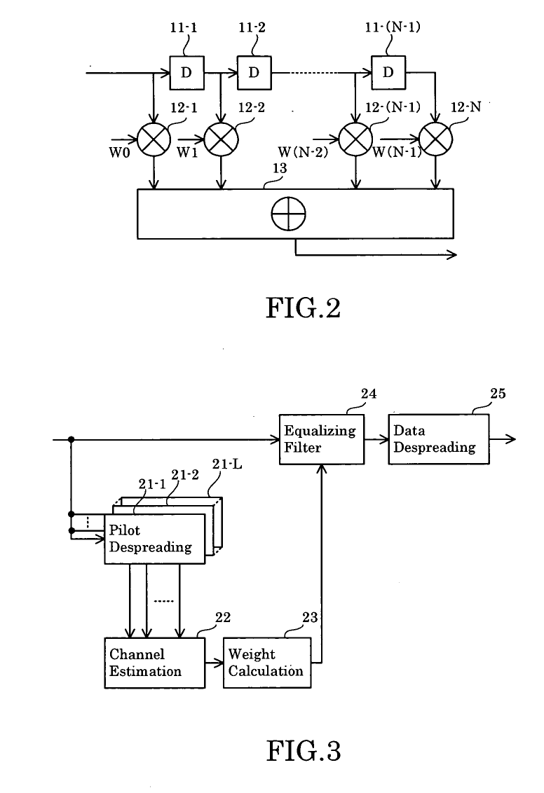

An exemplary configuration of the equalizing filter is illustrated in FIG. 2. The equalizing filter, which is constituted by a FIR filter carrying out convolution operations, delays the received signals for each sample with the help of delay devices 11-1 to 11-(N-1), multiplies the outputs of the taps by the weights w₀ to W_{N-1} using the multipliers 12-1 to 12-N, and sums up the respective outputs using an adder 13.

In the present invention, the pilot signals are not directly fast-Fourier transformed, but channel estimation is performed in the time domain and a fast Fourier transform is taken of the impulse responses of the transmission channel. As a result, GI insertion in the pilot signal portion becomes unnecessary. Moreover, GI insertion in the data signal portion can be rendered unnecessary by filtering (equalization) of data signals in the time domain. Furthermore, the computational burden can be greatly reduced because weight calculations, which constitute a major portion of the entire computational burden of the receiver, are performed in the frequency domain.

Although in the embodiment described above the number of transmit and receive antennas is one antenna of each type, the present invention can be reduced to practice in a similar manner in case of linear filter reception using the MIMO (Multiple Input Multiple Output) system, in which a plurality of transmit and receive antennas are utilized.

In addition, the present invention can be used both for base station wireless devices and portable wireless devices in a mobile communication system.

What is claimed is:

1. A CDMA receiver comprising:
an equalizing filter equalizing received code division multiplex (CDMA) signals,
data despreading means demodulating data signals by despreading equalized signals,
channel estimation means obtaining impulse responses of the transmission channel, and
weight calculation means calculating the weights of the equalizing filter based on the obtained impulse responses,
wherein the CDMA receiver is adapted such that signal processing is performed, respectively, in the real time domain by the channel estimation means and the equalizing filter and in the frequency domain by the weight calculation means, and comprises Fourier transform means for converting the impulse responses obtained by the channel estimation means into frequency domain signals and inverse Fourier transform means for converting the frequency domain weights calculated by the weight calculation means into time domain weights.

2. A CDMA reception method for receiving signals transmitted using the CDMA system, comprising:
obtaining impulse responses of a transmission channel by time-domain signal processing,
Fourier transforming and converting the impulse responses into frequency domain signals,
calculating equalizing filter weights using the frequency domain impulse responses,
converting the calculated frequency domain weights into time domain weights using an inverse Fourier transform,
filtering the received signals using time-domain signal processing, and
demodulating data signals by despreading the equalized signals.

3. A wireless communication system comprising a transmitter(s), which transmits code division multiplex signals, and the CDMA receiver(s) described in claim 1, which receives signals transmitted by the transmitter(s).
